(19) United States
(12) Patent Application Publication
(10) Pub. No.: US 2009/0151828 A1
(43) Pub. Date: Jun. 18, 2009

(54) TIRE WITH ANTENNA ENCAPSULATED WITH RUBBER COMPOUND CONTAINING THERMOPLASTIC

(76) Inventors: Junling Zhao, Hudson, OH (US); Robert Leon Benedict, Tallmadge, OH (US); David John Zanzig, Uniontown, OH (US); Samuel Patrick Landers, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/957,422

(22) Filed: Dec. 15, 2007

(51) Int. Cl. B60C 19/00

(52) U.S. Cl. 152/152.1

(57) ABSTRACT

The present invention is directed to a pneumatic tire comprising an electronic sensing device at least partially encapsulated by an elastomeric composition, the elastomeric composition comprising:
100 parts by weight of at least one elastomer; and
from 25 to 100 parts by weight, per 100 parts by weight of elastomer (phr) of a thermoplastic having a melting temperature ranging of less than 200° C.

### BACKGROUND OF THE INVENTION

It is useful in myriad commercial product applications to embed a sensing device into a rubber article for the purpose of sensing a physical parameter of the article. One such application is the incorporation of a relatively rigid RFID transponder into a tire in order to detect and measure the pressure within the tire and communicate the pressure level to an external reader. It is also common to employ annular apparatus, including an antenna, for electronically transmitting tire or wheel identification or other data at radio frequency. The apparatus includes a radio-frequency transponder comprising an integrated circuit chip having data capacity at least sufficient to retain identification information for the tire or wheel. Other data, such as the inflation pressure of the tire or the temperature of the tire or wheel at the transponder location, can be transmitted by the transponder along with the identification data.

Such sensing devices may be mounted to the tire and encapsulated or otherwise partially or fully covered with an elastomeric material. The electrical properties of the elastomeric material, specifically the electrical permittivity, are important in successfully transmitting information from the sensor. It is desirable, then, to have an elastomeric material suitable for encapsulating or otherwise partially or fully cover a tire sensing device, wherein the elastomeric material has a low permittivity.

In the description of the invention, the term “phr” relates to parts by weight of a particular ingredient per 100 parts by weight of rubber contained in a rubber composition. The terms “rubber” and “elastomer” are used interchangeably unless otherwise indicated, the terms “cure” and vulcanize” may be used interchangeably unless otherwise indicated and the terms “rubber composition” and “rubber compound” may be used interchangeably unless otherwise indicated. The term “butyl type rubber” is used herein to refer to butyl rubber (copolymer of isobutylene with a minor amount comprised of, for example about 1 to about 3 percent, of units derived from isoprene or paramethylene styrene), and halobutyl rubber as chlorobutyl rubber and bromobutyl rubber (chlorinated and brominated butyl rubber, respectively) unless otherwise indicated.

### BRIEF DESCRIPTION OF THE DRAWINGS

FIG. 1 is a cut away view of one embodiment of the tire of the present invention.

FIG. 2 is an expanded view showing details of the tire of FIG. 1.

FIG. 3 is an alternate embodiment of the present invention.

FIG. 4 is a graph of electrical permittivity measured for several rubber compositions.

### SUMMARY OF THE INVENTION

The present invention is directed to a pneumatic tire comprising an electronic sensing device at least partially encapsulated by an elastomeric composition, the elastomeric composition comprising:

100 parts by weight of at least one elastomer; and

from 25 to 100 parts by weight, per 100 parts by weight of elastomer (phr) of a thermoplastic having a melting temperature ranging of less than 200° C.

### DESCRIPTION OF THE INVENTION

There is disclosed a pneumatic tire comprising an electronic sensing device at least partially encapsulated by an elastomeric composition, the elastomeric composition comprising:

100 parts by weight of at least one elastomer; and

from 25 to 100 parts by weight, per 100 parts by weight of elastomer (phr) of a thermoplastic having a melting temperature ranging of less than 200° C.

It has been found unexpectedly that an inclusion in the rubber composition of a thermoplastic results in a composition having a surprisingly low electrical permittivity, making the rubber composition especially suitable for use as an encapsulation material for a tire sensing device.

In one embodiment, the thermoplastic is present in the rubber composition as a disperse phase, with the thermoplastic dispersed in an elastomeric continuous phase. For this embodiment, the rubber composition is obtained by conventional rubber mixing and calendaring. Such a dispersion of the thermoplastic in a continuous elastomeric phase is obtained by mixing of the thermoplastic with the elastomer without curatives in an initial, so-called non-productive mix step to obtain the two-phase mixture. This is followed by addition and mixing of curatives in a productive mix step.

In another embodiment, the thermoplastic is present in the rubber composition as a continuous phase, with the elastomer existing as disperse phase in the thermoplastic continuous phase. Such a disperse elastomer phase in a continuous thermoplastic phase may be obtained utilizing dynamic vulcanization. In such a dynamically vulcanized composition, dispersion of the elastomeric phase in the continuous thermoplastic phase is obtained by vulcanization of the elastomeric phase containing curatives during high temperature extrusion mixing with the thermoplastic; as the elastomer cures the shear induced by mixing causes the elastomer to form small particulates dispersed in the thermoplastic. See for example Tracey, D. S., and A. H. Tsou, Dynamically Vulcanized Alloy Innerliners, Rubber World, September 2007, pp 17-21.

In another embodiment, the thermoplastic is present in the rubber composition as a mixed dispersed and continuous phase, with region of the compositions showing the thermoplastic dispersed, and other regions showing the thermoplastic as continuous.

The rubber composition for use in the present invention includes an elastomer. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis 1,4 polybutadiene), polyisoprene (including cis 1,4 polyisoprene), butyl rubber, halobutyl rubber such as chlorobutyl rubber or bromobutyl rubber, styrene/isoprene/butadiene rubber, copolymers of 1,3 butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. In one embodiment, the elastomers include but are not limited to butyl type rubber, including butyl rubber and halobutyl rubbers such as chlorobutyl rubber and bromobutyl rubber, copolymers of isobutylene and paramethylstyrene, synthetic polyisoprene, natural rubber, styrene butadiene rubber, and polybutadiene.

An alternative butyl rubber for the rubber composition is comprised of a brominated copolymer of isobutylene and paramethylstyrene. The brominated copolymer conventionally contains from about 0.3 to about 2 weight percent bromination. Exemplary of such a brominated copolymer is Exxpro® from ExxonMobil Chemical reportedly having a Mooney (ML 1+8) viscosity at 125° C. of from about 45 to about 55, a paramethylstyrene content of about 5 weight percent, isobutylene content of about 94 to about 95 weight percent, and a bromine content of about 0.8 weight percent. Alternately, the butyl rubber may be comprised of a combination of a copolymer of isobutylene and isoprene together with a brominated copolymer of isobutylene and paramethylstyrene.

The rubber composition includes a thermoplastic. Suitable thermoplastics have a melting temperature of less than 200° C. Suitable thermoplastics include but are not limited to polyamides, polyethylenes, polypropylenes, and poly(ethylene vinyl alcohol)s.

In one embodiment, the thermoplastic is a low melting point polyamide, or nylon. By low melting point polyamide, it is meant that the polyamide exhibits a relatively low melting temperature, sufficiently low to ensure melting and dispersion of the polyamide at temperatures used to mix the rubber composition, typically 200° C. or less. In one embodiment, the polyamide has a melting point temperature of less than 160° C. as determined by ASTM D3418. In one embodiment, the polyamide has a melting point temperature of less than 140° C. as determined by ASTM D3418. In one embodiment, the polyamide has a melting point temperature of less than 120° C. as determined by ASTM D3418.

Suitable low melting point polyamides include various nylon copolymers, terpolymers and multipolymers including but not limited to nylon 6/66/610, nylon 6/66/612, nylon 6/66/610/612, and the like. The melting point of such polyamides is dependent on the relative proportions of the monomers used in the production of the polyamide, as described for example in U.S. Pat. No. 2,388,035.

Suitable low melting point polyamides are available commercially as the Elvamide® series from DuPont, including but not limited to Elvamide® 8061, 8063, 8066, and 8023R.

In addition to the aforesaid elastomers and thermoplastic, the rubber composition may also contain other conventional ingredients commonly used in rubber vulcanizates, for example, tackifier resins, processing aids, carbon black, silica, talc, clay, mica, antioxidants, antiozonants, stearic acid, activators, waxes and oils as may be desired. Carbon black and/or silica may be used in a range, for example, of from 20 to 60 phr. The said composition may contain, for example, at least one of talc, clay, mica and calcium carbonate, and their mixtures, in a range, for example, of about 2 to 25 phr depending upon various physical properties desired for the composition. Typical amounts of processing aids may, for example, range from about 1 to 15 phr.

The vulcanization of the compound is conducted in the presence of a sulfur vulcanizing agent. Examples of suitable sulfur vulcanizing agents include elemental sulfur (free sulfur) or sulfur donating vulcanizing agents, for example, an amine disulfide, polymeric disulfide or sulfur olefin adducts. Preferably, the sulfur vulcanizing agent is elemental sulfur. As known to those skilled in the art, sulfur vulcanizing agents are used in an amount ranging from about 0.2 to 5.0 phr with a range of from about 0.5 to 3.0 being preferred.

Accelerators are used to control the time and/or temperature required for vulcanization and to improve the properties of the vulcanizate. A single accelerator system may be used, i.e., primary accelerator in conventional amounts ranging from about 0.5 to 3.0 phr. In the alternative, combinations of 2 or more accelerators may be used which may consist of a primary accelerator which is generally used in the larger amount (0.3 to 3.0 phr), and a secondary accelerator which is generally used in smaller amounts (0.05 to 1.0 phr) in order to activate and to improve the properties of the vulcanizate. Combinations of these accelerators have been known to produce a synergistic effect on the final properties and are somewhat better than those produced by either accelerator alone. In addition, delayed action accelerators may be used which are not effected by normal processing temperatures but produce satisfactory cures at ordinary vulcanization temperatures. Suitable types of accelerators that may be used are amines, disulfides, guanidines, thioureas, thiazoles, thiurams, sulfenamides, dithiocarbamate and xanthates. Preferably, the primary accelerator is a disulfide or sulfenamide.

Various synthetic, amorphous silicas may be used for the elastomeric composition, where it is desired that the composition contains a silica. Representative of such silicas are, for example and not intended to be limiting, precipitated silicas as, for example, HiSil 210™ and HiSil 243™ from PPG Industries, as well as various precipitated silicas from J. M. Huber Company, various precipitated silicas from Degussa Company and various precipitated silicas from Rhodia Company.

Various coupling agents may be used for the various synthetic, amorphous silicas, particularly the precipitated silicas, to couple the silica aggregates to various of the elastomers. Representative of such coupling agents are, for example and not intended to be limiting, bis(3-trialkoxysilylpropyl) polysulfides wherein at least two, and optionally all three, of its alkoxy groups are ethoxy groups and its polysulfidic bridge is comprised of an average of from about 2 to about 4, alternatively from about 2 to about 2.6 or an average of from about 3.4 to about 3.8 connecting sulfur atoms, and an alkoxyorganomercaptosilane which may optionally have its mercapto moiety blocked with a suitable blocking agent during the mixing thereof with the rubber composition, wherein said alkoxy group is preferably an ethoxy group.

The rubber composition may also include a material that acts as a compatibilizer between the continuous elastomeric phase and the thermoplastic phase. Suitable compatibilizers include phenol resins combined with metal salt catalysts. In one embodiment, the compatibilizer is a methylphenol resin and stannous chloride. Other suitable compatibilizers include methylene donor/methylene acceptor pairs. In one embodiment, the methylene donor/methylene acceptor-type compatibilizer is resorcinol and hexamethylenetetramine.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. Alternatively and as discussed earlier herein, the mixing may be done using a dynamic vulcanization technique.

In practice the rubber composition, or compound, is formed into a gum strip. As known to those skilled in the art, a gum strip is produced by a press or passing a rubber compound through a mill, calender, multi-head extruder or other suitable means. Preferably, the gum strip is produced by a calender because greater uniformity is believed to be provided.

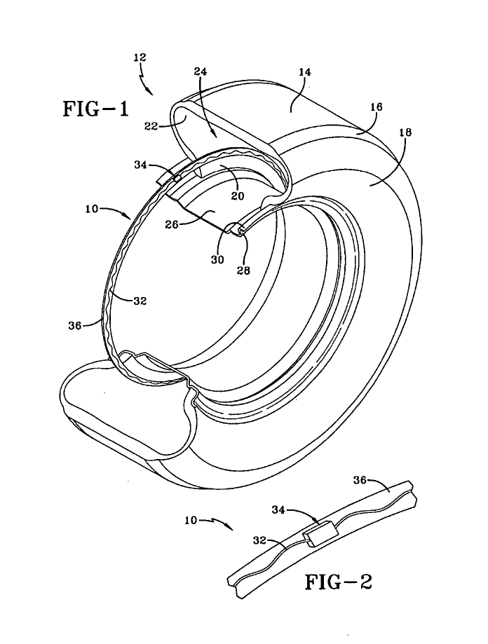

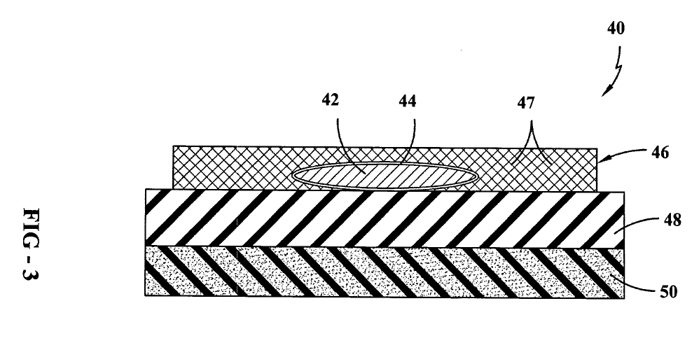

Referring now to FIGS. 1 and 2, one embodiment 10 of the subject invention is shown deployed within a tire 12, for example, disposed on the tire innerliner 22. The tire 12 is formed from conventional materials such as rubber or rubber composites by conventional means and may comprise a radial ply or bias ply configuration. A typical tire 12 is configured having a tread 14, a shoulder 16, an annular sidewall 18, and a terminal bead 20. An innerliner 22 is formed and defines a tire cavity 24. The tire 12 is intended for mounted location upon an annular rim 26 having a peripheral rim flange 28 and an outer rim flange surface 30. Rim 26 is conventionally configured and composed of a suitably strong metal such as steel.

As an electronic sensing device an annular antenna 32 is provided and, in one embodiment, embodies a sinusoidal configuration. Antenna 32 may be alternatively configured into alternative patterns or comprise a straight wire(s) if desired and may be filament wire, or cord or stranded wire. Antenna 32 may be incorporated into the tire by means of a carrier strip as described below.

With continued reference to FIGS. 1 and 2, as part of the electronic sensing device a tag carrier 34 is provided and may include means for sensing tire parameters such as pressure and temperature. Included as a part of the apparatus 10 is a carrier strip of material 36 formed into the annular configuration shown. Carrier strip 36 is formed as a gum strip of the elastomeric composition of the present invention, with a relatively low permittivity. The strip 36 is formed to substantially encapsulate the antenna wire(s) 32 and at least a portion of the tag carrier 34. In the post manufacturing state shown in FIG. 1, therefore, the apparatus 10 comprises antenna 32, tag carrier 34, and carrier strip 36, in a unitary, generally circular, assembly. The diameter of the apparatus assembly 10 is a function of the size of the tire 12. The preferred location of the antenna assembly 10 on the tire is on the tire just above the rim flange 30. Such a location minimizes stress forces on the assembly from operation of the tire and minimizes interference to RF communication between the tag and an external reader (not shown) that might otherwise be caused by the metal rim. Other mounting locations of the antenna assembly 10 on the tire, however, may be employed if desired for specific tire applications.

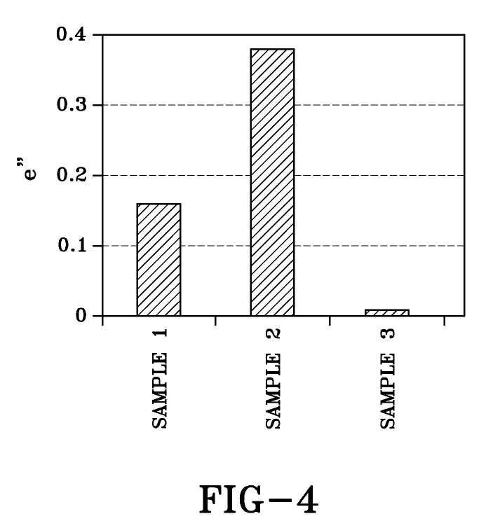

With reference now to FIG. 3, another embodiment of the present invention shows in schematic representation a transponder carrier device 40. As an electronic sensing device the transponder 42 is represented generically and, according to the invention, may be any electronics device that is intended to function at an embedded location within a host article. Of particular application is the incorporation of an RFID device or tag within the rubber composite material of a tire for the purpose of identifying the tire. The device 40 may also include a sensor component for monitoring a tire condition such as pressure, and communicating the pressure reading to an external reader (not shown). The transponder device 40 is typically rigid in construction. The transponder device 40 is coated with a coating 44 of adhesive of a type commercially available in the industry. A reinforcement cap 46 covers the transponder 42 and a base layer 48 and boding layer 50 underlies the transponder 42 and cap 46.

The completed carrier 40 may be referred to alternatively as a “patch.” Such a patch may for example be disposed on the innerliner of a tire. The patch 40 is an assembly of green compound layers 46, 48, 50. One or more of the layers 46, 48 and 50 may be formed from a gum strip of the elastomeric compound of the present invention, comprising an elastomer and thermoplastic. Adding a tag geometry 42 into the patch 40 can trap small quantities of air and limit expansion of the cap 46 due to trapped air around the tag. The cross-woven cap configuration 46 including cords 47 prevents trapped air from bubbling up and keeps the transponder 42 stationary and attached.

The carrier 40 thus is shown to have three distinct layers although more or fewer layers may be employed if desired. The cap 46 is preferably although not necessarily of rubber compound that is cord reinforced by cords 47. Cords 47 may be composed of various textile or non-textile materials and is preferably although not necessarily in a square woven configuration. The base layer 48 is made of a productive non-reinforced rubber and the bonding layer 50 is made of a non-productive rubber that having curatives received from either a glue or adhesive or from the green compound to which it is applied. The transponder 42 is coated with an adhesive dip that bonds to the cap and base material.

Vulcanization of the tire of the present invention is generally carried out, for example, at temperatures of between about 100° C. and 200° C. Preferably, the vulcanization is conducted at temperatures ranging from about 111° C. to 180° C. Any of the usual vulcanization processes may be used such as heating in a press or mold, heating with superheated steam or hot salt or in a salt bath. Preferably, the heating is accomplished in a press or mold in a method known to those skilled in the art of tire curing.

The following examples are presented in order to illustrate but not limit the present invention.

### EXAMPLE 1

In this example, the effect of dispersing a low melting polyamide in a synthetic polyisoprene rubber composition on the electrical permittivity of the composition is illustrated. Three rubber compositions were mixed using a two phase mixing procedure, with addition of the elastomers and polyamide in a first, non-productive mix step, followed by addition of conventional amounts of curatives in a second, productive mix step, to obtain a compound with a disperse polyamide phase in a continuous elastomer phase. Samples 1 and 2 were controls and were standard butyl rubber innerliner compounds. Sample 3 represents the current invention and was a blend of 60 parts by weight of synthetic polyisoprene (Natsyn® from Goodyear) and 40 parts by weight of polyamide (Elvamide® 8066 from DuPont).

Compound samples were cured under conventional conditions and then measured for electrical permittivity e″. Permittivity measurements for the three tested samples is shown in FIG. 4. As can be seen from FIG. 4, the permittivity e″ for the inventive compound Sample 3 is unexpectedly much lower than that for the control compounds Samples 1 and 2. A low electrical permittivity is desirable in an antenna encapsulating compound, as lower resistance to transmission of electromagnetic signals from the antenna is realized.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising an electronic sensing device at least partially encapsulated by an elastomeric composition, the elastomeric composition comprising:
100 parts by weight of at least one elastomer; and
from 25 to 100 parts by weight, per 100 parts by weight of elastomer (phr) of a thermoplastic having a melting temperature ranging of less than 200° C.

2. The pneumatic tire of claim 1, wherein the concentration of the thermoplastic ranges from 40 to 70 phr.

3. The pneumatic tire of claim 1, wherein the elastomer is selected from the group consisting of butyl rubber, chlorobutyl rubber, bromobutyl rubber, natural rubber, copolymers of isobutylene and paramethylstyrene, brominated copolymers of isobutylene and paramethylstyrene, EPDM, styrene-butadiene rubber, polybutadiene and synthetic polyisoprene.

4. The pneumatic tire of claim 1, wherein the thermoplastic is selected from the group consisting of polyamides, polyethylenes, polypropylenes, and poly(etheylene vinyl alcohol)s.

5. The pneumatic tire of claim 1, wherein the thermoplastic is a polyamide having a melting temperature of less than 160° C.

6. The pneumatic tire of claim 1, wherein the elastomer exists as a continuous phase and the thermoplastic is dispersed as a discontinuous phase in the elastomeric continuous phase.

7. The pneumatic tire of claim 1, wherein the thermoplastic exists as a continuous phase and the elastomer is dispersed as a discontinuous phase in the polyamide continuous phase.

8. The pneumatic tire of claim 1, wherein the thermoplastic exists both as a continuous phase and as a discontinuous phase.

9. The pneumatic tire of claim 1, wherein the rubber composition further comprises a compatibilizer.

10. The pneumatic tire of claim 1, wherein the rubber composition further comprises a compatibilizer selected from phenol resin/metal salt pairs and methylene donor/methylene acceptor pairs.

11. The pneumatic tire of claim 1, wherein the electronic sensing device at least partially encapsulated by an elastomeric composition is disposed on an innerliner of the tire.
